(19) United States
(12) Patent Application Publication
(10) Pub. No.: US 2008/0143836 A1
(43) Pub. Date: Jun. 19, 2008

(54) VIDEO SURVEILLANCE CAMERA WITH COVERT FIELD OF VIEW

(75) Inventors: Richard Nowicki, Mapleville, RI (US); Robert Mansfield, Sterling, MA (US)

Correspondence Address: BARLOW, JOSEPHS & HOLMES, LTD., 101 DYER STREET, 5TH FLOOR, PROVIDENCE, RI, 02903, US

(73) Assignee: VIDEOLOGY IMAGING SOLUTIONS, INC., Greenville, RI (US)

(21) Appl. No.: 11/777,527

(22) Filed: Jul. 13, 2007

Related U.S. Application Data
(60) Provisional application No. 60/832,297, filed on Jul. 21, 2006.

(51) Int. Cl. H04N 7/18

(52) U.S. Cl. 348/151; 348/159; 348/143; 348/E07.085

(57) ABSTRACT

A video surveillance camera is provided that includes a first camera objective directed towards a primary surveillance field of view and at least a second camera objective that is concealed within the camera and directed towards a second covert field of view. The second camera objective is mounted within the camera body in a manner that makes it undetectable, while allowing the camera objective to freely observe the covert field of view. In a first embodiment, the video camera includes a first camera objective affixed to the front of the camera housing and at least a second camera objective mounted in a fixed, concealed position within the housing. Alternately, the at least one second camera objective may be mounted within the housing in an adjustable fashion to allow the second camera objective to be aimed independently of the camera housing orientation itself.

### CROSS-REFERENCE TO RELATED APPLICATIONS

This application is related to and claims priority from earlier filed U.S. Provisional Patent Application No. 60/832,297, filed Jul. 21, 2006.

### BACKGROUND OF THE INVENTION

The present invention relates generally to security monitoring devices such as video surveillance cameras. More specifically, the present invention relates to a video surveillance camera that includes the capability for monitoring both an overt surveillance objective and at least one covert surveillance objective.

Generally, in the field of security and surveillance, it is well known that video security cameras are considered a useful tool for enhancing safety in public and/or secure areas as well as for deterring undesirable behavior such as theft or vandalism. The implementation of a video surveillance system allows the activity within the system's field of view to be monitored for identification, for alerting the system operator to the occurrence of unwanted activity or intrusions, for the deterrence of theft by customers and/or employees, and/or for providing a signal that may be recorded for later reference or potential use as evidence. For example, security cameras are commonly used to monitor activities in airports, banks, shopping areas, parking lots, train stations, etc.

In a typical security surveillance system, one or more video security cameras are placed so as to provide a field of view of an objective area under surveillance. Each of the video cameras includes a lens arrangement on the front thereof to capture a visual image. In turn, these video cameras convert the captured visual images into an electronic form suitable for transmission. A control station, either co-located within the surveillance area or remote from the area, receives the signals from these cameras and displays the captured image at a console for security assessment and recording. Typically, a person monitors the images from the cameras on a video screen and initiates security measures if the received image indicates unauthorized activities.

In order for a surveillance system to produce images of multiple, widely separated objective areas or fields of view, the system typically includes placement of multiple video cameras, each trained on a desired field of view, or the use of a panning video camera arrangement to allow the video camera to be moved between two separated areas to be surveyed. In the case of panning video cameras, the resulting images are often undesirable because not only does the image frequently become blurred due to lack of proper focus, but also it is possible to miss the observance of a given event in a particular area when the video camera is not trained on that area. Similarly, the use of multiple video cameras that are each trained on a desired field of view can lead to the creation of various blind spots throughout the surveillance area. As a result, those familiar with the video camera installation and orientation may take advantage of the blind spots to allow their activities to go unnoticed.

The existence of blind spots in fixed video camera surveillance systems is particularly problematic due to the typical construction of a traditional prior art video security camera. As stated above, video security cameras have a body with a lens array mounted thereon, wherein the lens array is pointed at the area to be surveyed. In such cases, the presence of the lens array also telegraphs the direction in which the video camera is pointed. As a result, careful observation of the video cameras by a would be miscreant can allow them to quickly identify those areas that are not covered within the field of view of the surveillance system.

In order to overcome the above noted problems, there have been some prior art closed circuit television systems that are designed to reproduce juxtaposed images of two separated areas electronically. Electronic systems for accomplishing this purpose, however, are often complex and relatively expensive. Moreover, electronic systems do not typically allow the use of varying focal length lenses for increasing or decreasing the magnification of the subjects in the areas of interest. Further, such systems often comprise two pairs of mirrors that reflect light from a pair of separated optical fields toward an image plane in a juxtaposed relationship. The image plane is positioned a predetermined distance from a lens of a video camera whereby the images directed on the image plane are reproduced by the video camera. However, optical systems of this design have several problems. Firstly, when mirrors are used in an optical system there is a loss of resolution because of the light lost due to the reflection off of the mirrors. In addition, while more than one field of vision is being observed, such observation is still being accomplished by a visible lens array pointed at each of the fields under surveillance. Further, the use of mirrors increases the difficulty of setting up and aligning the reflected light from the respective optical fields onto the image plane.

There is therefore a need for a video security camera that is capable of monitoring a plurality of surveillance fields of view simultaneously. There is a further need for a video security camera that is capable of monitoring a plurality of surveillance fields wherein one of the surveillance fields is overt and at least one of the plurality of additional surveillance fields is covert. There is still a further need for a video security camera that includes both an overt and a covert field of view, thereby reducing the existence of predictable blind spots within the area to be surveyed.

### BRIEF SUMMARY OF THE INVENTION

In this regard, the present invention provides a surveillance video camera that includes a first video camera objective directed towards a primary surveillance field of view and at least a second video camera objective that is concealed within the surveillance video camera housing and is directed towards a second covert field of view. The second video camera objective is mounted within the camera body in a manner that makes it undetectable, while allowing the video camera objective to freely observe the covert field of view. The surveillance video camera of the present invention therefore allows both the primary field of view as well as the covert field of view to be monitored simultaneously. As a result, such a surveillance video camera configuration greatly reduces the occurrence of easily detectable blind spots thereby preventing such blind spots from being exploited.

In a first embodiment, the surveillance video camera includes a first camera objective affixed to the front of the video camera housing and a second camera objective mounted in a fixed, concealed position within the housing. Alternately, the second camera objective may be mounted within the housing in an adjustable fashion to allow the second camera objective to be aimed independently of the video camera housing orientation itself. In yet a further embodiment, the video camera may include a plurality of concealed camera objectives thereby allowing the video camera to observe a corresponding plurality of covert fields of view.

It is therefore an object of the present invention to provide a video security camera that is capable of monitoring a plurality of surveillance fields of view simultaneously. It is a further object of the present invention to provide a video security camera that is capable of monitoring a plurality of surveillance fields wherein one of the surveillance fields is overt and at least one of the plurality of additional surveillance fields is covert. It is still a further object of the present invention to provide a video security camera that includes both an overt and a covert field of view thereby reducing the existence of predictable blind spots within the area to be surveyed.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a side perspective view of a video surveillance camera having an overt field of view and a covert field of view in accordance with the present invention;

FIG. 2 is a side view of a second embodiment video surveillance camera having an overt field of view and a plurality of covert fields of view in accordance with the present invention;

FIG. 3 is a side view of a video surveillance camera having an overt field of view and a covert field of view that is adjustable relative to the overt field of view;

FIG. 4 is a side perspective view of the video surveillance camera of FIG. 3 wherein the covert field of view is manually adjustable relative to the overt field of view; and

FIG. 5 is a side perspective view of the video surveillance camera of FIG. 3 wherein the covert field of view is automatically adjustable relative to the overt field of view.

### DETAILED DESCRIPTION OF THE INVENTION

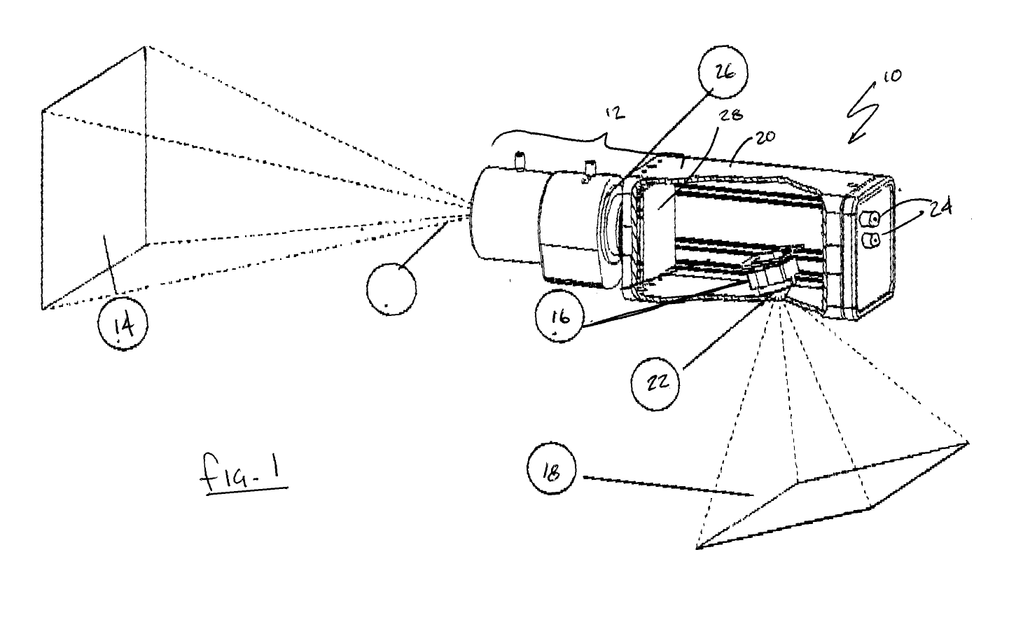

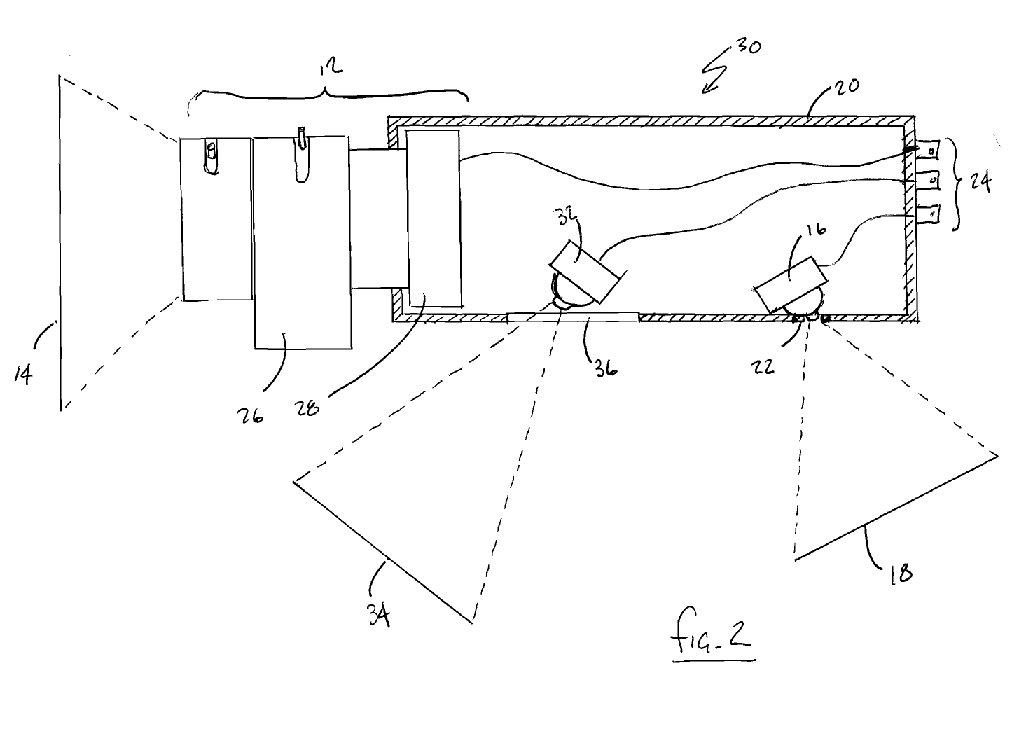

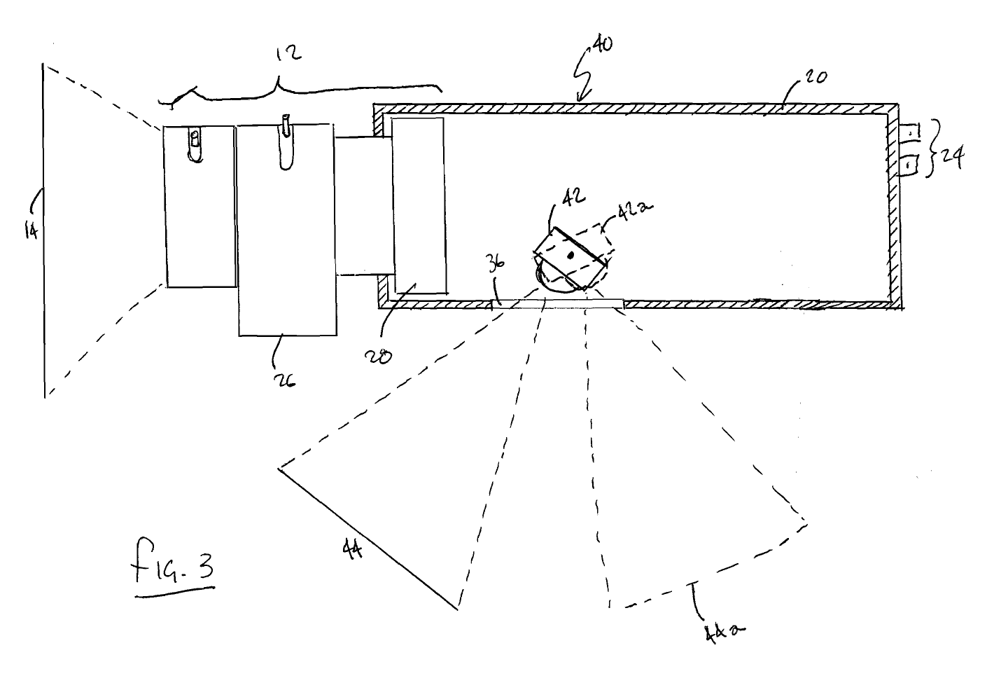

Now referring to the drawings, the surveillance video camera of the present invention is shown and generally illustrated in the figures wherein a first embodiment is shown in FIG. 1 having one overt field of view and one covert field of view, a second embodiment in FIG. 2 depicts a surveillance video camera having one overt field of view and a plurality of covert fields of view and a third embodiment surveillance video camera is depicted in FIG. 3 having an overt field of view and an adjustable covert field of view.

Turning now FIG. 1, the present invention is generally directed to a surveillance video camera 10 that includes a first image capturing assembly 12 for capturing and transmitting a first field of view 14 and at least one second image capturing assembly 16 for capturing and transmitting a least one second field of view 18, wherein the second field of view 18 is different from the first field of view 14. It is also preferred that the video surveillance camera 10 include a housing 20 wherein the first image capturing assembly 12 is positioned overtly on the housing 20 and directed to a first field of view 14 as is the case with traditional video camera technology, while the second image capturing assembly 16 is concealed within the housing 20 of the surveillance video camera 10 and is directed towards a second covert field of view 18.

As can be seen in FIG. 1, the second image capturing assembly 16 is mounted within the video surveillance camera 10 housing 20 in a manner that makes it nearly undetectable upon viewing the exterior of the housing 20. Further, a small aperture 22 is provided in the housing 20 extending between the interior and exterior thereof thereby allowing the second image capturing assembly 16 to freely observe the covert field of view 18 through the provided aperture 22. The surveillance video camera 10 of the present invention therefore allows both the primary field of view 14 as well as the covert field of view 18 to be monitored simultaneously. In this regard, outputs 24 are provided on the rear of the housing 20 to allow connections of transmission cabling thereto thereby providing for the transmission of information from each of the video capturing assemblies 12, 16 contained within the video surveillance camera 10. In this particular embodiment of the video surveillance camera 10 of the present invention, the second image capturing assembly 16 is mounted in a fixed position within the housing 20 and relative to the first image capturing assembly 12. Accordingly, aiming of the first and second image capture assemblies view is simply accomplished by positioning the video surveillance camera 10 as desired to capture the required survey areas. As a result, such a surveillance video camera 10 configuration greatly reduces the occurrence of easily detectable blind spots, thereby preventing such blind spots from being exploited.

In the context of the present invention, the image capturing assemblies 12, 16 are preferably video capture devices as are already known in the art such as video cameras. Generally, the first image capturing assembly includes 12 a conventional lens 26 and a chip 28 that serves to capture the first field of vision 14 and transmit that information to a monitoring station via the output 24. Similarly, the second image capturing assembly 16 is preferably a small sized video camera such as a pinhole camera or the like. The second image capturing assembly 16 also serves to capture the second field of vision 18 and transmit the information via output 24. It should be appreciated by one skilled in the art that while specific structure has been described and depicted as being suitable as image capturing assemblies, such disclosure is meant to be illustrative and is not intended to limit the possible range of devices that are suitable within the scope of the invention.

Turning now to FIG. 2, a second embodiment video surveillance camera 30 is provided that includes two second image capturing devices 16, 32. The first second image capturing device 16 captures its own distinct covert field of view 18 while the second image capturing device 32 captures yea another covert field of view 34. In this regard, a plurality of second image capturing devices may be installed into the housing 20 of the video surveillance camera 30 each capable of capturing its own covert field of view. While two second image capturing devices 16, 32 are shown, clearly such a device could also include 3 or even 10 additional second image capturing devices for surveying additional covert fields of view. It can also be seen that one of the second image capturing assemblies 16 is positioned behind an aperture 22 in the housing 20 as described above while an alternate second image capturing assembly 32 is positioned behind a panel 36 positioned in the housing 20 such that the panel 36 conceals the second image capturing assembly 32 in that the panel 32 is partially transparent so that the camera is concealed from external view yet can capture an image field through the panel 32.

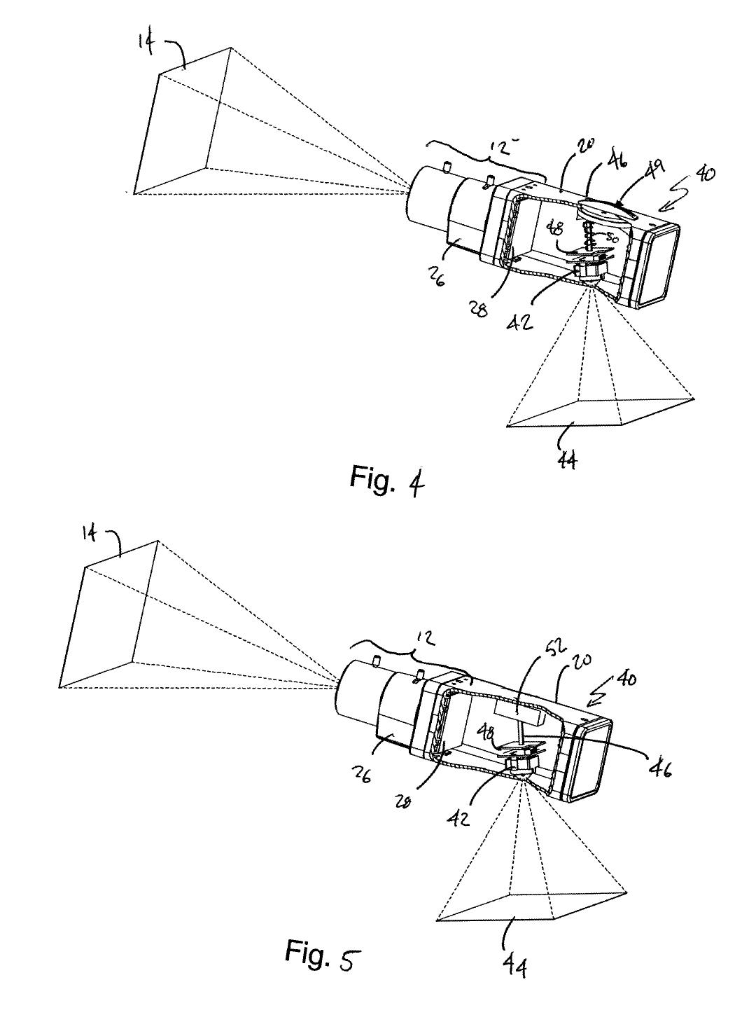

In yet a third embodiment video surveillance camera 40, as depicted in FIG. 3, the second image capturing device 42 is mounted within the housing 20 in an adjustable fashion to allow the second image capturing device 42 to be moved as illustrated by the dotted image at 42a to capture an alternate covert field of view 44a so that the second image capturing device 42 can be aimed, manually or remotely, independently of the video surveillance camera 40 housing 20 orientation itself. This allows further improvement in the area to be surveyed and a greater reduction in blind spots in that the second covert field of view 44 can be defined when the video surveillance camera 40 is set up such that the second covert field 44 is totally independent of the video surveillance camera 40 orientation and the location of the first overt field of vision 14. Turning to FIG. 4 it can be seen that adjustment of the second image capturing device 42 is accomplished manually through the use of an actuator positioned on the exterior of the housing. In this regard the second image capture device 42 is mounted to a carrier 48 that id in turn connected to the actuator 46. In this regard, movement of the actuator 46 allows the operator to rotate and tilt the second image capture device 42 relative to the video surveillance camera 40 housing 20. It can be further seen that the actuator 46 is supported in a rotating disk 49 such that rotating the disk 49 engages the flat profile of the actuator 46 causing it in turn to rotate the carrier 48 and the second image capture device 42. The second image capture device 42 is supported against the wall of the housing 20 with the lens extending through the aperture 22 such that the second image capture device 42 can swivel freely. It is further preferable, that the second image capture device 42 is maintained in position against the wall of the housing 20 by a spring 50 that is received around the actuator 46 and exerts downward pressure against the carrier 48 and in turn the second image capture device 42.

Turning to FIG. 5, the present invention also provides for adjustment of the second image capturing device 42 remotely through the use of internally or externally mounted remotely controlled actuators 52 of the type commonly known in the art.

It can therefore be seen that the present invention provides a video surveillance camera that is capable of monitoring a plurality of surveillance fields of view simultaneously. Further the present invention provides a video security camera that is capable of monitoring a plurality of surveillance fields wherein one of the surveillance fields is overt and at least one of the plurality of additional surveillance fields is covert. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A video camera assembly comprising:
a first image capturing assembly for capturing and transmitting a first field of view; and
at least one second image capturing assembly for capturing and transmitting a least one second field of view, wherein said second field of view is different from said first field of view.

2. The video camera assembly of claim 1, wherein a portion of said first image capturing assembly is visible from an exterior of said video camera assembly and said at least one second image capturing assembly is fully concealed within said video camera assembly.

3. The video camera assembly of clam 1, wherein said at least one second image capturing assembly is exactly one second image capturing assembly.

4. The video camera assembly of clam 1, wherein said at least one second image capturing assembly is a plurality of second image capturing assemblies.

5. The video camera assembly of claim 1, wherein said second field of view captured by said at least one second image capturing assembly is manually adjustable relative to and independent of said first field of view via controls accessible from an exterior of said video camera assembly.

6. The video camera assembly of claim 1, wherein said second field of view captured by said at least one second image capturing assembly is remotely adjustable relative to and independent of said first field of view via remotely controlled actuators.

7. The video camera assembly of claim 1, further comprising:
a housing having an interior, an exterior and an aperture extending between said interior and said exterior, wherein said first image capturing assembly is at least partially exposed on an exterior of said housing and said second image capturing assembly is contained entirely within said housing, said second image capturing assembly capturing said second field of view through said aperture.

8. The video camera assembly of claim 1, further comprising:
a housing having an interior, an exterior and a partially transparent panel therein, wherein said first image capturing assembly is at least partially exposed on an exterior of said housing and said second image capturing assembly is contained entirely within said housing, said second image capturing assembly capturing said second field of view through said panel, concealing internal camera from external view.

9. The video camera assembly of claim 1, wherein said first image capturing assembly is a first video camera and said second image capturing assembly is a second video camera, said first and second video cameras being mounted using a common housing.

10. A video surveillance device comprising:
a first video camera configured for capturing and transmitting a first overt field of view; and
at least one second video camera configured for capturing and transmitting a least one second covert field of view, wherein said second covert field of view is different from said first overt field of view.

11. The video surveillance device of claim 10, further comprising:
a housing having an interior and an exterior, wherein said at least one second video camera is at least one pinhole camera positioned on said interior of said housing, a lens on said at least one pinhole camera being directed to said exterior of said housing.

12. The video surveillance device of claim 11, wherein said at least one pinhole camera is directed to said exterior of said housing via an aperture in said housing.

13. The video surveillance device of claim 11, wherein said at least one pinhole camera is directed to said exterior of said housing via a panel in said housing, concealing said camera from external view.

14. The video surveillance device of claim 10, wherein said first video camera and said at least one second video camera can be aimed independent of one another.

15. The video surveillance device of claim 14, wherein said aiming of said second video camera is manually adjustable relative to and independent of said first video camera via controls accessible from an exterior of said housing.

16. The video surveillance device of claim 14, wherein said aiming of said second video camera is manually adjustable relative to and independent of said first video camera via remotely controlled actuators.

17. A video surveillance device comprising:
a housing;
an overt video camera at least partially disposed on an exterior of said housing, said first video camera configured for capturing and transmitting a first overt field of view; and
at least one covert video camera disposed on an interior of said housing, said at least one covert video camera configured for capturing and transmitting a least one second covert field of view, wherein said second covert field of view is different from said first overt field of view.
